(19) United States
(12) Patent Application Publication
(10) Pub. No.: US 2024/0397092 A1
(43) Pub. Date: Nov. 28, 2024

(54) METHOD, APPARATUS AND COMPUTER PROGRAM PRODUCT FOR STORING, ENCODING OR DECODING ONE OR VERTICES OF A MESH IN A VOLUMETRIC VIDEO CODING BITSTREAM

(71) Applicant: Nokia Technologies Oy, Espoo (FI)

(72) Inventors: Lukasz KONDRAD, Munich (DE); Sebastian SCHWARZ, Munich (DE); Christoph BACHHUBER, Munich (DE); Lauri Aleksi ILOLA, Tampere (FI)

(21) Appl. No.: 18/694,697

(22) PCT Filed: Sep. 22, 2022
(86) PCT No.: PCT/IB2022/058977

§ 371 Date: Mar. 22, 2024

Related U.S. Application Data
(60) Provisional application No. 63/261,862, filed on Sep. 30, 2021.

(51) Int. Cl. H04N 19/597; H04N 19/172

(52) U.S. Cl. CPC H04N 19/597; H04N 19/172

(57) ABSTRACT

A method, an apparatus, and a computer program product are provided. An example method includes generating an extension to a volumetric video coding structure, wherein the extension to the volumetric coding structure enables at least one of the following: storage of information corresponding to an algorithm for compression of a mesh; prediction of single vertex values between mesh frames; generation of a volumetric video coding bitstream consisting of attribute video components that is mapped to the mesh; or conversion of a first file format to a second file format; and storing a vertex of the mesh by using the extension.

### TECHNICAL FIELD

The examples and non-limiting embodiments relate generally to volumetric video coding, and more particularly, to storing, encoding, or decoding one or more vertices of a mesh in a volumetric video coding bitstream.

### BACKGROUND

It is known to perform video coding and decoding.

### SUMMARY

An example method includes generating an extension to a volumetric video coding structure, wherein the extension to the volumetric coding structure enables at least one of the following: storage of information corresponding to an algorithm for compression of a mesh; prediction of single vertex values between mesh frames; generation of a volumetric video coding bitstream consisting of attribute video components that is mapped to the mesh; or conversion of a first file format to a second file format; and storing a vertex of the mesh by using the extension.

The example method may further include, wherein the volumetric video coding comprises a visual volumetric video-based coding (V3C), the volumetric video coding structure comprises V3C structure and the volumetric video coding bitstream comprises a V3C bitstream.

The example method may further include, wherein the first file format comprises a draco (drc) file format and the second file format comprises a visual volumetric video-based coding (V3C) file format.

The example method may further include, wherein the algorithm comprises an edgebreaker algorithm and the information corresponding to the algorithm comprises edgebreaker information.

The example method may further include, wherein the information corresponding to an algorithm for compression of a mesh comprises at least one of a vertex information, mapping to a coordinate texture (uv) texture, or connectivity information.

The example method may further include generating, by using the algorithm, at least one of order of: vertices in the mesh or a connectivity information; storing the vertex, an intra frame, and an inter frame in a volumetric video coding patch data; storing the connectivity information as one of: a new patch type capable of storing string of bits or a new network abstraction later (NAL) unit type.

The example method may further include defining at least one of: an encoding type field to indicate a method used to encode the string; data length field to indicate a length of data comprising the string; or string data field comprising i-th bit of the bitstream of the length indicated by the data length field.

The example method may further include, wherein the vertex comprises more than one coordinate texture (uv) values assigned to the vertex, and wherein a uv mapping is stored as a part of one of: a new patch type or a new network abstraction layer (NAL) unit type.

The example method may further include defining a count field to indicate number of uv values assigned to the vertex.

The example method may further include generating an extension to a patch data unit.

The example method may further include, wherein the extension to the patch data unit comprises uv count used to indicate a number of uv values mapped or assigned to the vertex.

The example method may further include defining an uv index to indicate an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example method may further include, wherein the raw byte sequence payload is provided on tile basis.

The example method may further include, wherein when a mesh comprises an edge, vertices describing the edge are indicated and stored one after another.

The example method may further include indicating that vertices are encoded using a parallelogram prediction when the vertices are encoded using the parallelogram prediction.

The example method may further include using an orientation index, and wherein the orientation index with value 0 indicates that the vertex is from the edge, and wherein the orientation index with value 1 indicates that the vertex is not from the edge and is stored as is, and wherein the orientation index with value 2 indicates that the vertex is not from the edge and is predicted by using the parallelogram prediction.

The example method may further include providing a number of the edge vertices, a number of normal vertices, or a number of parallelogram vertices as part of a new patch type or a new network abstraction layer unit type.

The example method may further include defining at least one of: a first count field for indicating the number of vertices that are the edge vertices; a second count filed for indicating the number of vertices that are the normal vertices; or a third count field for indicating the number vertices stored using the parallelogram prediction.

The example method may further include defining a tile identity field for specifying a tile identity to which a syntax element in a raw byte sequence payload associated with the algorithm apply.

Another example method includes receiving a bitstream comprising a vertex of a mesh, wherein the vertex is stored by using an extension to a volumetric video coding structure; wherein the extension to the volumetric coding structure enables at least one of the following: storage of information corresponding to an algorithm for compression of a mesh; prediction of single vertex values between mesh frames; generation of a volumetric video coding bitstream consisting of attribute video components that is mapped to the mesh; or conversion of a first file format to a second file format; and decoding the bitstream.

The example method may further include, wherein the volumetric video coding comprises a visual volumetric video-based coding (V3C), the volumetric video coding structure comprises V3C structure and the volumetric video coding bitstream comprises a V3C bitstream.

The example method may further include, wherein the first file format comprises a draco (drc) file format and the second file format comprises a visual volumetric video-based coding (V3C) file format.

The example method may further include, wherein the algorithm comprises an edgebreaker algorithm and the information corresponding to the algorithm comprises edgebreaker information.

The example method may further include, wherein the information corresponding to an algorithm for compression of a mesh comprises at least one of a vertex information, mapping to a coordinate texture (uv) texture, or connectivity information.

The example method may further include: accessing at least one of order of: vertices in the mesh or a connectivity information; retrieving the vertex, an intra frame, and an inter frame in a volumetric video coding patch data; retrieving the connectivity information as one of: a new patch type capable of storing string of bits or a new network abstraction later (NAL) unit type.

The example method may further include accessing at least one of: an encoding type field, wherein the encoding type field is used to indicate a method used to encode the string; a data length field, wherein the data length field is used to indicate a length of data comprising the string; or a string data field, wherein the string data field comprises i-th bit of the bitstream of the length indicated by the data length field.

The example method may further include, wherein the vertex comprises more than one coordinate texture (uv) values assigned to the vertex, and wherein a uv mapping is stored as a part of one of: a new patch type or a new network abstraction layer (NAL) unit type.

The example method may further include accessing a count field, wherein the count field indicates a number of uv values assigned to the vertex.

The example method may further include accessing an extension to a patch data unit.

The example method may further include, wherein the extension to the patch data unit comprises uv count used to indicate a number of uv values mapped or assigned to the vertex.

The example method may further include accessing an uv index, wherein the uv index indicates an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example method may further include, wherein the raw byte sequence payload is provided on tile basis.

The example method may further include, wherein when a mesh comprises an edge, vertices describing the edge are indicated and stored one after another.

The example method may further include accessing information indicating that vertices are encoded using a parallelogram prediction, when the vertices are encoded using the parallelogram prediction.

The example method may further include accessing a value from an orientation index, and wherein the orientation index with value 0 indicates that the vertex is from the edge, and wherein the orientation index with value 1 indicates that the vertex is not from the edge and is stored as is, and wherein the orientation index with value 2 indicates that the vertex is not from the edge and is predicted by using the parallelogram prediction.

The example method may further include accessing information regarding a number of edge vertices, a number of normal vertices, or a number of parallelogram vertices as part of a new patch type or a new network abstraction layer unit type.

The example method may further include accessing at least one of: a first count field, wherein the first count field indicates the number of vertices that are the edge vertices; a second count filed, wherein the second count field indicates for indicating the number of vertices that are the normal vertices; or a third count field, wherein the third count field indicates the number vertices stored using the parallelogram prediction.

The example method may further include accessing a tile identity field, wherein the tile identity field specifies a tile identity to which a syntax element in a raw byte sequence payload associated with the algorithm apply.

A yet another example method includes generating an extension to a volumetric video coding structure, wherein the extension to the volumetric coding structure enables storage of information corresponding to an algorithm for compression of a mesh; and storing one or more vertices of the mesh by using the extension.

The example method may further include, wherein the extension further enables at least one of the following: prediction of single vertex values between mesh frames; generation of a volumetric video coding bitstream consisting of attribute video components that is mapped to the mesh; or conversion of a first file format to a second file format.

The example method may further include, wherein the volumetric video coding comprises a visual volumetric video-based coding (V3C), the volumetric video coding structure comprises V3C structure, and the volumetric video coding bitstream comprises a V3C bitstream.

The example method may further include, wherein the first file format comprises a draco (drc) file format and the second file format comprises a visual volumetric video-based coding (V3C) file format.

The example method may further include, wherein the algorithm comprises an edgebreaker algorithm and the information corresponding to the algorithm comprises edgebreaker information.

The example method may further include, wherein the information corresponding to an algorithm for compression of a mesh comprises at least one of: one or more vertices information, mapping to a coordinate texture (uv) texture, or connectivity information.

The example method may further include generating, by using the algorithm, at least one of order of: vertices in the mesh or a connectivity information; storing the one or more vertices, an intra frame, and an inter frame in a volumetric video coding patch data; storing the connectivity information as one of: a new patch type capable of storing string of bits or a new network abstraction later (NAL) unit type.

The example method may further include defining at least one of: an encoding type field to indicate a method used to encode the string; data length field to indicate a length of data comprising the string; or string data field comprising i-th bit of the bitstream of the length indicated by the data length field.

The example method may further include, wherein the one or more vertices comprise more than one coordinate texture (uv) values assigned to the one or more vertices, and wherein a uv mapping is stored as a part of one of: a new patch type or a new network abstraction layer (NAL) unit type.

The example method may further include defining a count field to indicate number of uv values assigned to the one or more vertices.

The example method may further include generating an extension to a patch data unit.

The example method may further include, wherein the extension to the patch data unit comprises uv count used to indicate a number of uv values mapped or assigned to the one or more vertices.

The example method may further include defining an uv index to indicate an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example method may further include, wherein the raw byte sequence payload is provided on tile basis.

The example method may further include, wherein when a mesh comprises an edge, vertices describing the edge are indicated and stored one after another.

The example method may further include indicating that the one or more vertices are encoded using a parallelogram prediction, when the one or more vertices are encoded using the parallelogram prediction.

The example method may further include using an orientation index, and wherein the orientation index with value 0 indicates that the one or more vertices are from the edge, and wherein the orientation index with value 1 indicates that the one or more vertices are not from the edge and is stored as is, and wherein the orientation index with value 2 indicates that the one or more vertices are not from the edge and is predicted by using the parallelogram prediction.

The example method may further include providing a number of edge vertices, a number of normal vertices, or a number of parallelogram vertices as part of a new patch type or a new network abstraction layer unit type.

The example method may further include defining at least one of: a first count field for indicating the number of vertices that are the edge vertices; a second count filed for indicating the number of vertices that are normal vertices; or a third count field for indicating the number vertices stored using the parallelogram prediction.

The example method may further include defining a tile identity field for specifying a tile identity to which a syntax element in a raw byte sequence payload associated with the algorithm apply.

A still another example method includes receiving a bitstream comprising one or more vertices of a mesh, wherein the one or more vertices are stored by using an extension to a volumetric video coding structure; wherein the extension to the volumetric coding structure enables storage of information corresponding to an algorithm for compression of a mesh; and decoding the bitstream.

The example method may further include, wherein the extension further enables at least one of the following: prediction of single vertex values between mesh frames; generation of a volumetric video coding bitstream consisting of attribute video components that is mapped to the mesh; or conversion of a first file format to a second file format.

The example method may further include, wherein the volumetric video coding comprises a visual volumetric video-based coding (V3C), the volumetric video coding structure comprises V3C structure and the volumetric video coding bitstream comprises a V3C bitstream.

The example method may further include, wherein the first file format comprises a draco (drc) file format and the second file format comprises a visual volumetric video-based coding (V3C) file format.

The example method may further include, wherein the algorithm comprises an edgebreaker algorithm and the information corresponding to the algorithm comprises edgebreaker information.

The example method may further include, wherein the information corresponding to an algorithm for compression of a mesh comprises at least one of a vertex information, mapping to a coordinate texture (uv) texture, or connectivity information.

The example method may further include accessing at least one of order of: vertices in the mesh or a connectivity information; retrieving the vertex, an intra frame, and an inter frame in a volumetric video coding patch data; retrieving the connectivity information as one of: a new patch type capable of storing string of bits or a new network abstraction later (NAL) unit type.

The example method may further include accessing at least one of: an encoding type field, wherein the encoding type field is used to indicate a method used to encode the string; a data length field, wherein the data length field is used to indicate a length of data comprising the string; or a string data field, wherein the string data field comprises i-th bit of the bitstream of the length indicated by the data length field.

The example method may further include, wherein the vertex comprises more than one coordinate texture (uv) values assigned to the vertex, and wherein a uv mapping is stored as a part of one of: a new patch type or a new network abstraction layer (NAL) unit type.

The example method may further include accessing a count field, wherein the count field indicates a number of uv values assigned to the vertex.

The example method may further include accessing an extension to a patch data unit.

The example method may further include, wherein the extension to the patch data unit comprises uv count used to indicate a number of uv values mapped or assigned to the vertex.

The example method may further include accessing an uv index, wherein the uv index indicates an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example method may further include, wherein the raw byte sequence payload is provided on tile basis.

The example method may further include, wherein when a mesh comprises an edge, vertices describing the edge are indicated and stored one after another.

The example method may further include accessing information indicating that vertices are encoded using a parallelogram prediction, when the vertices are encoded using the parallelogram prediction.

The example method may further include accessing a value from an orientation index, and wherein the orientation index with value 0 indicates that the vertex is from the edge, and wherein the orientation index with value 1 indicates that the vertex is not from the edge and is stored as is, and wherein the orientation index with value 2 indicates that the vertex is not from the edge and is predicted by using the parallelogram prediction.

The example method may further include accessing information regarding a number of edge vertices, a number of normal vertices, or a number of parallelogram vertices as part of a new patch type or a new network abstraction layer unit type.

The example method may further include accessing at least one of: a first count field, wherein the first count field indicates the number of vertices that are the edge vertices; a second count filed, wherein the second count field indicates for indicating the number of vertices that are normal vertices; or a third count field, wherein the third count field indicates the number vertices stored using the parallelogram prediction.

The example method may further include accessing a tile identity field, wherein the tile identity field specifies a tile identity to which a syntax element in a raw byte sequence payload associated with the algorithm apply.

An example apparatus includes at least one processor; and at least one non-transitory memory comprising computer program code; wherein the at least one memory and the computer program code are configured to, with the at least one processor, cause the apparatus at least to perform: generate an extension to a volumetric video coding structure, wherein the extension to the volumetric coding structure enables at least one of the following: storage of information corresponding to an algorithm for compression of a mesh; prediction of single vertex values between mesh frames; generation of a volumetric video coding bitstream consisting of attribute video components that is mapped to the mesh; or conversion of a first file format to a second file format; and storing a vertex of the mesh by using the extension.

The example apparatus may further include, wherein the volumetric video coding comprises a visual volumetric video-based coding (V3C), the volumetric video coding structure comprises V3C structure and the volumetric video coding bitstream comprises a V3C bitstream.

The example apparatus may further include, wherein the first file format comprises a draco (drc) file format and the second file format comprises a visual volumetric video-based coding (V3C) file format.

The example apparatus may further include, wherein the algorithm comprises an edgebreaker algorithm and the information corresponding to the algorithm comprises edgebreaker information.

The example apparatus may further include, wherein the information corresponding to an algorithm for compression of a mesh comprises at least one of a vertex information, mapping to a coordinate texture (uv) texture, or connectivity information.

The example apparatus may be further caused to: generate, by using the algorithm, at least one of order of: vertices in the mesh or a connectivity information; store the vertex, an intra frame, and an inter frame in a volumetric video coding patch data; store the connectivity information as one of: a new patch type capable of storing string of bits or a new network abstraction later (NAL) unit type.

The example apparatus may be further include, wherein the apparatus is caused to define at least one of: an encoding type field to indicate a method used to encode the string; data length field to indicate a length of data comprising the string; or string data field comprising i-th bit of the bitstream of the length indicated by the data length field.

The example apparatus may further include, wherein the vertex comprises more than one coordinate texture (uv) values assigned to the vertex, and wherein a uv mapping is stored as a part of one of: a new patch type or a new network abstraction layer (NAL) unit type.

The example apparatus may further include, wherein the apparatus is further caused to define a count field to indicate number of uv values assigned to the vertex.

The example apparatus may further include, wherein the apparatus is further caused to generate an extension to a patch data unit.

The example apparatus may further include, wherein the extension to the patch data unit comprises uv count used to indicate a number of uv values mapped or assigned to the vertex.

The example apparatus may further include, wherein the apparatus is further caused to define an uv index to indicate an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example apparatus may further include, wherein the raw byte sequence payload is provided on tile basis.

The example apparatus may further include, wherein when a mesh comprises an edge, vertices describing the edge are indicated and stored one after another.

The example apparatus may further include, wherein the apparatus is further caused to indicate that vertices are encoded using a parallelogram prediction, when the vertices are encoded using the parallelogram prediction.

The example apparatus may further include, wherein the apparatus is further caused to use an orientation index, and wherein the orientation index with value 0 indicates that the vertex is from the edge, and wherein the orientation index with value 1 indicates that the vertex is not from the edge and is stored as is, and wherein the orientation index with value 2 indicates that the vertex is not from the edge and is predicted by using the parallelogram prediction.

The example apparatus may further include, wherein the apparatus is further caused to provide a number of the edge vertices, a number of normal vertices, or a number of parallelogram vertices as part of a new patch type or a new network abstraction layer unit type.

The example apparatus may further include, wherein the apparatus is further caused to define at least one of: a first count field for indicating the number of vertices that are the edge vertices; a second count filed for indicating the number of vertices that are the normal vertices; or a third count field for indicating the number vertices stored using the parallelogram prediction.

The example apparatus may further include, wherein the apparatus is further caused to define a tile identity field for specifying a tile identity to which a syntax element in a raw byte sequence payload associated with the algorithm apply.

An another example apparatus includes; and at least one non-transitory memory comprising computer program code; wherein the at least one memory and the computer program code are configured to, with the at least one processor, cause the apparatus at least to perform: receive a bitstream comprising a vertex of a mesh, wherein the vertex is stored by using an extension to a volumetric video coding structure; wherein the extension to the volumetric coding structure enables at least one of the following: storage of information corresponding to an algorithm for compression of a mesh; prediction of single vertex values between mesh frames; generation of a volumetric video coding bitstream consisting of attribute video components that is mapped to the mesh; or conversion of a first file format to a second file format; and decoding the bitstream.

The example apparatus may further include, wherein the volumetric video coding comprises a visual volumetric video-based coding (V3C), the volumetric video coding structure comprises V3C structure and the volumetric video coding bitstream comprises a V3C bitstream.

The example apparatus may further include, wherein the first file format comprises a draco (drc) file format and the second file format comprises a visual volumetric video-based coding (V3C) file format.

The example apparatus may further include, wherein the algorithm comprises an edgebreaker algorithm and the information corresponding to the algorithm comprises edgebreaker information.

The example apparatus may further include, wherein the information corresponding to an algorithm for compression of a mesh comprises at least one of a vertex information, mapping to a coordinate texture (uv) texture, or connectivity information.

The example apparatus may further include, wherein the apparatus is further caused to: access at least one of order of: vertices in the mesh or a connectivity information; retrieve the vertex, an intra frame, and an inter frame in a volumetric video coding patch data; retrieve the connectivity information as one of: a new patch type capable of storing string of bits or a new network abstraction later (NAL) unit type.

The example apparatus may further include, wherein the apparatus is further caused to access at least one of: an encoding type field, wherein the encoding type field is used to indicate a method used to encode the string; a data length field, wherein the data length field is used to indicate a length of data comprising the string; or a string data field, wherein the string data field comprises i-th bit of the bitstream of the length indicated by the data length field.

The example apparatus may further include, wherein the vertex comprises more than one coordinate texture (uv) values assigned to the vertex, and wherein a uv mapping is stored as a part of one of: a new patch type or a new network abstraction layer (NAL) unit type.

The example apparatus may further include, wherein the apparatus is further caused to access a count field, wherein the count field indicates a number of uv values assigned to the vertex.

The example apparatus may further include, wherein the apparatus is further caused to access an extension to a patch data unit.

The example apparatus may further include, wherein the extension to the patch data unit comprises uv count used to indicate a number of uv values mapped or assigned to the vertex.

The example apparatus may further include, wherein the apparatus is further caused to access an uv index, wherein the uv index indicates an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example apparatus may further include, wherein the raw byte sequence payload is provided on tile basis.

The example apparatus may further include, wherein when a mesh comprises an edge, vertices describing the edge are indicated and stored one after another.

The example apparatus may further include, wherein the apparatus is further caused to access information indicating that vertices are encoded using a parallelogram prediction, when the vertices are encoded using the parallelogram prediction.

The example apparatus may further include, wherein the apparatus is further caused to access a value from an orientation index, and wherein the orientation index with value 0 indicates that the vertex is from the edge, and wherein the orientation index with value 1 indicates that the vertex is not from the edge and is stored as is, and wherein the orientation index with value 2 indicates that the vertex is not from the edge and is predicted by using the parallelogram prediction.

The example apparatus may further include, wherein the apparatus is further caused to access information regarding a number of edge vertices, a number of normal vertices, or a number of parallelogram vertices as part of a new patch type or a new network abstraction layer unit type.

The example apparatus may further include, wherein the apparatus is further caused to access at least one of: a first count field, wherein the first count field indicates the number of vertices that are the edge vertices; a second count filed, wherein the second count field indicates for indicating the number of vertices that are the normal vertices; or a third count field, wherein the third count field indicates the number vertices stored using the parallelogram prediction.

The example apparatus may further include, wherein the apparatus is further caused to access a tile identity field, wherein the tile identity field specifies a tile identity to which a syntax element in a raw byte sequence payload associated with the algorithm apply.

A yet another apparatus includes at least one processor; and at least one non-transitory memory comprising computer program code; wherein the at least one memory and the computer program code are configured to, with the at least one processor, cause the apparatus at least to perform: generate an extension to a volumetric video coding structure, wherein the extension to the volumetric coding structure enables storage of information corresponding to an algorithm for compression of a mesh; and store one or more vertices of the mesh by using the extension.

The example apparatus may further include, wherein the extension further enables at least one of the following: prediction of single vertex values between mesh frames; generation of a volumetric video coding bitstream consisting of attribute video components that is mapped to the mesh; or conversion of a first file format to a second file format.

The example apparatus may further include, wherein the volumetric video coding comprises a visual volumetric video-based coding (V3C), the volumetric video coding structure comprises V3C structure, and the volumetric video coding bitstream comprises a V3C bitstream.

The example apparatus may further include, wherein the first file format comprises a draco (drc) file format and the second file format comprises a visual volumetric video-based coding (V3C) file format.

The example apparatus may further include, wherein the algorithm comprises an edgebreaker algorithm and the information corresponding to the algorithm comprises edgebreaker information.

The example apparatus may further include, wherein the information corresponding to an algorithm for compression of a mesh comprises at least one of: one or more vertices information, mapping to a coordinate texture (uv) texture, or connectivity information.

The example apparatus may further include, wherein the apparatus is further caused to: generate, by using the algorithm, at least one of order of: vertices in the mesh or a connectivity information; store the one or more vertices, an intra frame, and an inter frame in a volumetric video coding patch data; store the connectivity information as one of: a new patch type capable of storing string of bits or a new network abstraction later (NAL) unit type.

The example apparatus may further include, wherein the apparatus is further caused to define at least one of: an encoding type field to indicate a method used to encode the string; data length field to indicate a length of data comprising the string; or string data field comprising i-th bit of the bitstream of the length indicated by the data length field.

The example apparatus may further include, wherein the one or more vertices comprise more than one coordinate texture (uv) values assigned to the one or more vertices, and wherein a uv mapping is stored as a part of one of: a new patch type or a new network abstraction layer (NAL) unit type.

The example apparatus may further include, wherein the apparatus is further caused to define a count field to indicate number of uv values assigned to the one or more vertices.

The example apparatus may further include, wherein the apparatus is further caused to generate an extension to a patch data unit.

The example apparatus may further include, wherein the extension to the patch data unit comprises uv count used to indicate a number of uv values mapped or assigned to the one or more vertices.

The example apparatus may further include, wherein the apparatus is further caused to define an uv index to indicate an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example apparatus may further include, wherein the raw byte sequence payload is provided on tile basis.

The example apparatus may further include, wherein when a mesh comprises an edge, vertices describing the edge are indicated and stored one after another.

The example apparatus may further include, wherein the apparatus is further caused to indicate that the one or more vertices are encoded using a parallelogram prediction, when the one or more vertices are encoded using the parallelogram prediction.

The example apparatus may further include, wherein the apparatus is further caused to use an orientation index, and wherein the orientation index with value 0 indicates that the one or more vertices are from the edge, and wherein the orientation index with value 1 indicates that the one or more vertices are not from the edge and is stored as is, and wherein the orientation index with value 2 indicates that the one or more vertices are not from the edge and is predicted by using the parallelogram prediction.

The example apparatus may further include, wherein the apparatus is further caused to provide a number of edge vertices, a number of normal vertices, or a number of parallelogram vertices as part of a new patch type or a new network abstraction layer unit type.

The example apparatus may further include, wherein the apparatus is further caused to define at least one of: a first count field for indicating the number of vertices that are the edge vertices; a second count filed for indicating the number of vertices that are normal vertices; or a third count field for indicating the number vertices stored using the parallelogram prediction.

The example apparatus may further include, wherein the apparatus is further caused to define a tile identity field for specifying a tile identity to which a syntax element in a raw byte sequence payload associated with the algorithm apply.

A still another example apparatus includes at least one processor; and at least one non-transitory memory comprising computer program code; wherein the at least one memory and the computer program code are configured to, with the at least one processor, cause the apparatus at least to perform: receive a bitstream comprising one or more vertices of a mesh, wherein the one or more vertices are stored by using an extension to a volumetric video coding structure; wherein the extension to the volumetric coding structure enables storage of information corresponding to an algorithm for compression of a mesh; and decode the bitstream.

The example apparatus may further include, wherein the extension further enables at least one of the following: prediction of single vertex values between mesh frames; generation of a volumetric video coding bitstream consisting of attribute video components that is mapped to the mesh; or conversion of a first file format to a second file format.

The example apparatus may further include, wherein the volumetric video coding comprises a visual volumetric video-based coding (V3C), the volumetric video coding structure comprises V3C structure and the volumetric video coding bitstream comprises a V3C bitstream.

The example apparatus may further include, wherein the first file format comprises a draco (drc) file format and the second file format comprises a visual volumetric video-based coding (V3C) file format.

The example apparatus may further include, wherein the algorithm comprises an edgebreaker algorithm and the information corresponding to the algorithm comprises edgebreaker information.

The example apparatus may further include, wherein the information corresponding to an algorithm for compression of a mesh comprises at least one of a vertex information, mapping to a coordinate texture (uv) texture, or connectivity information.

The example apparatus may further include, wherein the apparatus is further caused to: access at least one of order of: vertices in the mesh or a connectivity information; retrieve the vertex, an intra frame, and an inter frame in a volumetric video coding patch data; retrieve the connectivity information as one of: a new patch type capable of storing string of bits or a new network abstraction later (NAL) unit type.

The example apparatus may further include, wherein the apparatus is further caused to access at least one of: an encoding type field, wherein the encoding type field is used to indicate a method used to encode the string; a data length field, wherein the data length field is used to indicate a length of data comprising the string; or a string data field, wherein the string data field comprises i-th bit of the bitstream of the length indicated by the data length field.

The example apparatus may further include, wherein the vertex comprises more than one coordinate texture (uv) values assigned to the vertex, and wherein a uv mapping is stored as a part of one of: a new patch type or a new network abstraction layer (NAL) unit type.

The example apparatus may further include, wherein the apparatus is further caused to access a count field, wherein the count field indicates a number of uv values assigned to the vertex.

The example apparatus may further include, wherein the apparatus is further caused to access an extension to a patch data unit.

The example apparatus may further include, wherein the extension to the patch data unit comprises uv count used to indicate a number of uv values mapped or assigned to the vertex.

The example apparatus may further include, wherein the apparatus is further caused to access an uv index, wherein the uv index indicates an index of a value of a u axis of a 2 dimensional texture associate with the algorithm and a value of v axis of the 2 dimensional texture associate with the algorithm, wherein the value of the u axis and the v axis are listed in a raw byte sequence payload associated with the algorithm.

The example apparatus may further include, wherein the raw byte sequence payload is provided on tile basis.

The example apparatus may further include, wherein when a mesh comprises an edge, vertices describing the edge are indicated and stored one after another.

The example apparatus may further include, wherein the apparatus is further caused to access information indicating that vertices are encoded using a parallelogram prediction, when the vertices are encoded using the parallelogram prediction.

The example apparatus may further include, wherein the apparatus is further caused to access a value from an orientation index, and wherein the orientation index with value 0 indicates that the vertex is from the edge, and wherein the orientation index with value 1 indicates that the vertex is not from the edge and is stored as is, and wherein the orientation index with value 2 indicates that the vertex is not from the edge and is predicted by using the parallelogram prediction.

The example apparatus may further include, wherein the apparatus is further caused to access information regarding a number of edge vertices, a number of normal vertices, or a number of parallelogram vertices as part of a new patch type or a new network abstraction layer unit type.

The example apparatus may further include, wherein the apparatus is further caused to access at least one of: a first count field, wherein the first count field indicates the number of vertices that are the edge vertices; a second count filed, wherein the second count field indicates for indicating the number of vertices that are normal vertices; or a third count field, wherein the third count field indicates the number vertices stored using the parallelogram prediction.

The example apparatus may further include, wherein the apparatus is further caused to access a tile identity field, wherein the tile identity field specifies a tile identity to which a syntax element in a raw byte sequence payload associated with the algorithm apply.

An example computer readable medium includes program instructions for causing an apparatus to perform at least the following: generate an extension to a volumetric video coding structure, wherein the extension to the volumetric coding structure enables at least one of the following: storage of information corresponding to an algorithm for compression of a mesh; prediction of single vertex values between mesh frames; generation of a volumetric video coding bitstream consisting of attribute video components that is mapped to the mesh; or conversion of a first file format to a second file format; and store a vertex of the mesh by using the extension.

The example computer readable medium may further include, wherein the apparatus is further caused to perform the methods as described in previous paragraphs.

The example computer readable medium may further include, wherein the computer readable medium comprises a non-transitory computer readable medium.

An another computer readable medium includes program instructions for causing an apparatus to perform at least the following: receive a bitstream comprising a vertex of a mesh, wherein the vertex is stored by using an extension to a volumetric video coding structure; wherein the extension to the volumetric coding structure enables at least one of the following: storage of information corresponding to an algorithm for compression of a mesh; prediction of single vertex values between mesh frames; generation of a volumetric video coding bitstream consisting of attribute video components that is mapped to the mesh; or conversion of a first file format to a second file format; and decode the bitstream.

The example computer readable medium may further include, wherein the apparatus is further caused to perform the methods as described in previous paragraphs.

The example computer readable medium may further include, wherein the computer readable medium comprises a non-transitory computer readable medium.

A yet another computer readable medium includes program instructions for causing an apparatus to perform at least the following: generate an extension to a volumetric video coding structure, wherein the extension to the volumetric coding structure enables storage of information corresponding to an algorithm for compression of a mesh; store one or more vertices of the mesh by using the extension.

The example computer readable medium may further include, wherein the apparatus is further cased to perform the methods as described in any of the previous paragraphs.

The example computer readable medium may further include, wherein the computer readable medium comprises a non-transitory computer readable medium.

A still another computer readable medium includes program instructions for causing an apparatus to perform at least the following: receive a bitstream comprising one or more vertices of a mesh, wherein the one or more vertices are stored by using an extension to a volumetric video coding structure; wherein the extension to the volumetric coding structure enables storage of information corresponding to an algorithm for compression of a mesh; and decode the bitstream.

The example computer readable medium may further include, wherein the apparatus is further caused to perform the methods as described in any of the previous paragraphs.

The example computer readable medium may further include, wherein the computer readable medium comprises a non-transitory computer readable medium

### BRIEF DESCRIPTION OF THE DRAWINGS

The foregoing aspects and other features are explained in the following description, taken in connection with the accompanying drawings, wherein:

FIG. 1 represents how a raw patch stores x, y, z values of each point (vertex) within Y component of a video frame.

FIG. 2 is a block diagram of an apparatus that may be configured in accordance with an example embodiment.

FIG. 3 is an example apparatus, which may be implemented in hardware, configured to store, encode, or decode a vertex of a mesh of a volumetric video coding, based on the examples described herein.

FIG. 4 illustrates an example method for storing a vertex of a mesh of a volumetric video coding in a bitstream, in accordance with an embodiment.

FIG. 5 illustrates an example method for decoding a bitstream comprising a vertex of a mesh of a volumetric video coding, in accordance with an embodiment.

FIG. 6 illustrates an example method for storing one or more vertices of a mesh of a volumetric video coding in a bitstream, in accordance with an embodiment.

FIG. 7 illustrates an example method for decoding a bitstream comprising one or more vertices of a mesh of a volumetric video, in accordance with an embodiment.

### DETAILED DESCRIPTION OF EXAMPLE EMBODIMENTS

The following acronyms and abbreviations that may be found in the specification and/or the drawing figures are defined as follows:

| | |
|---|---|
| 2D or 2d | two-dimensional |
| 3D or 3d | three-dimensional |
| 6DOF | six degrees of freedom |
| ACL | atlas coding layer |
| AR | augmented reality |
| ASIC | application-specific integrated circuit |
| asps | atlas sequence parameter set |
| CC BY-SA | Creative Commons license permitting any of the 5R's |
| | (reuse, revise, remix, redistribute, and retain) to content |
| CGI | computer-generated imagery |
| CVS | coded V3C sequence |
| DIS | Draft International Standard |
| eb or EB | edgebreaker |
| HDR | high dynamic range |
| HMD | head mounted display |
| HRD | hypothetical reference decoder |
| id or ID | identifier |
| IEC | International Electrotechnical Commission |
| I/F | interface |
| I/O | input/output |
| ISO | International Organization for Standardization |
| LOD | level of detail |
| MIV | MPEG immersive video |
| MPEG | moving picture experts group |
| MPEG-I | MPEG immersive |
| MR | mixed reality |
| NAL or nal | network abstraction layer |
| NW | network |
| OBJ | geometry definition file format (also .OBJ) |
| pos | files containing text descriptions of a position (also .POS) |
| RBSP | raw byte sequence payload |
| SEI | supplemental enhancement information |
| SODB | string of data bits |
| u(n) | unsigned integer using n bits, e.g. u(1), u(2) |
| UE | user equipment |
| ue(v) | unsigned integer exponential Golomb coded syntax element |
| | with the left bit first |
| UV or uv | coordinate texture, where “U” or “u” and “V” or “v” are |
| | axes of a 2D texture |
| u(v) | unsigned integer, where the number of bits is determined |
| | by the value of other syntax elements |
| V3C | visual volumetric video-based coding |
| V-PCC | video-based point cloud coding/compression |
| VPS | V3C parameter set |
| VR | virtual reality |

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a ‘computer-readable storage medium,’ which refers to a non-transitory physical storage medium (e.g., volatile or non-volatile memory device), can be differentiated from a ‘computer-readable transmission medium,’ which refers to an electromagnetic signal.

A method, apparatus and computer program product are provided in accordance with example embodiments for encoding or decoding vertex of a mesh in a volumetric video coding bitstream.

In an example, the following describes in detail suitable apparatus and possible mechanisms for implementing features for storing data of an algorithm (e.g., edgebreaker) for compression of 3D meshes in a V3C bitstream.

### Edgebreaker

Edgebreaker is an algorithm for efficient compression of 3D meshes introduced by Jarek Rossignac [https://www.cc.gatech.edu/˜jarek/papers/EdgeBreaker.pdf (last accessed Sep. 24, 2021) and https://www.cs.cmu.edu/—alla/edgebreaker_simple.pdf (last accessed Sep. 24, 2021)].

Because of the performance and simplicity of edgebreaker, it has been adopted in popular mesh compression libraries.

As an example, edgebreaker is at the core of the Google Draco compression library. Google Draco is an open-source library for compressing and decompressing 3D geometric meshes and point clouds. It is intended to improve the storage and transmission of 3D graphics.

The algorithm traverses through all triangles of the mesh in a deterministic, spiral-like way, where:
Each new triangle is next to an already encoded one. This allows efficient compression of vertex coordinates and other attributes, such as normals. Instead of storing the absolute values, they may be predicted from an adjacent triangle (using a parallelogram prediction) and only store the difference between predicted and actual values, which is generally smaller as compared to the absolute values.
Each triangle encodes minimum information necessary to reconstruct mesh connectivity from the sequence. For simple meshes, edgebreaker uses 5 possible symbols per triangle (forming the so called CLERS string).
Because half of the descriptors are Cs, a trivial code (C=0, L=110, E=111, R=101, S=100) guarantees an upper bound of 2 bits per triangle.

### Visual Volumetric Video-Based Coding

ISO/IEC 23090-5 specifies a generic mechanism for visual volumetric video coding, visual volumetric video-based coding (V3C). The generic mechanism may be used by applications targeting volumetric content, such as point clouds, immersive video with depth and mesh representations of volumetric frames.

Two applications of V3C (ISO/IEC 23090-5) has been defined V-PCC (ISO/IEC 23090-5) and MIV (ISO/IEC 23090-12). Additionally, MPEG 3D graphics coding group (3DG) (ISO SC29 WG7) has started work on a third application of V3C e.g., mesh compression.

V3C provides following patch data units:
patch_data_unit-intra information, standalone patch
skip_patch_data_unit-indicates that patch data from a patch from reference frame should be used that have the same patch index
merge_patch_data_unit-indicates that patch data contains the difference from a patch from reference frame that has the same patch index
inter_patch_data_unit-indicates that patch data contains the difference from a patch from reference frame that that have an explicit index signaled by ipdu_patch_index

Patch index is implicitly provided based on the order the patches are stored in a tile. Each tile may contain several patches of different types. An example patch_data_unit syntax is described in Table 1.

TABLE 1
An example of patch_data_unit syntax structure

| | Descriptor |
|---|---|
| patch_data_unit( patchIdx ) { | |
| pdu_2d_pos_x[ patchIdx ] | u(v) |
| pdu_2d_pos_y[ patchIdx ] | u(v) |
| pdu_2d_delta_size_x[ patchIdx ] | se(v) |
| pdu_2d_delta_size_y[ patchIdx ] | se(v) |
| pdu_3d_pos_x[ patchIdx ] | u(v) |
| pdu_3d_pos_y[ patchIdx ] | u(v) |
| pdu_3d_pos_min_z[ patchIdx ] | u(v) |
| if( asps_normal_axis_max_delta_value_enabled_flag ) | |
| pdu_3d_pos_delta_max_z[ patchIdx ] | u(v) |
| pdu_projection_id[ patchIdx ] | u(v) |
| pdu_orientation_index[ patchIdx ] | u(v) |
| if( afps_lod_mode_enabled_flag ) { | |
| pdu_lod_enabled_flag[ patchIndex ] | u(1) |
| if( pdu_lod_enabled_flag[ patchIndex ] > 0 ) { | |
| pdu_lod_scale_x_minus1[ patchIndex ] | ue(v) |
| pdu_lod_scale_y[ patchIndex ] | ue(v) |
| } | |
| } | u(v) |
| if( asps_point_local_reconstruction_enabled_flag ) | |
| point_local_reconstruction_data( patchIdx ) | |
| } | |

By providing the number of different patch data unity type, V3C enables temporal prediction between atlas frame (e.g. patches metadata in atlas frame).

### Exploration Experiments on MESH in V3C

ISO/IEC SC29 WG7 input document M53369 “Report on EE4FE 2.6 mesh coding with V-PCC”.

The report proposed a framework that encodes the mesh connectivity first and then packs geometry and attributes using only raw patches according to the traversal order of the encoded connectivity. By using this framework, signaling of the reordering metadata is not required.

The report shows that using edgebreaker and RAW patches of V3C outperforms Google Draco on two of the sequences (Redandblack and Queen). However, it is worse than Draco on other sequences. The report does not mention how connectivity is stored in the V3C bitstream.

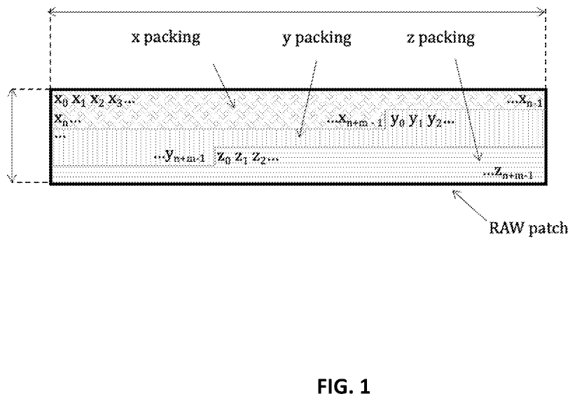

FIG. 1 represents how a raw patch stores x, y, z values of each point (vertex) within Y component of a video frame.

Encoding vertex position, or vertex position encoded using a parallelogram prediction, as raw data of a video frame may have following drawbacks, for example:
video coding tools may not be suited for compression of such data, which contains high spatial frequencies
video coding tools may introduce an error that is small in 2D video domain but may have significant impact on 3D reconstruction.

It has also been identified that the data that contribute the majority of bitrate in the compressed stream (e.g. >90%) is texture information. It is, therefore, feasible to use non-video coding tools to encode the vertex position with small impact on the overall compression.

Various embodiments propose:
extensions to existing V3C syntax structures that allow for storage of edgebraker information (e.g. vertex information, mapping to uv texture, connectivity information, and the like).
the extensions are proposed in a way that existing V3C encoder logic could provide an additional prediction of single vertex values between mesh frames.
a V3C bitstream that contains only attribute video component (e.g. texture) that is mapped to the mesh.
an entity that could convert Draco file format to V3C compatible storage.

In an embodiment, a V3C mesh encoder operates as follow:
For each mesh at a given time instance encoder uses edgebreaker to generate order of vertices (with associated uv attributes) and CLERS string providing connectivity information. Vertices may be or may not be encoded with parallelogram prediction
Each vertex is stored as V3C patch data of size 1×1
Patches in an intra frame (e.g. first encoded frame or a frame that all data from latter frames should reference to) are stored as intra patch data unit. An example of intra patch data unit includes, V3 patch data units (patch_data_unit syntax structure in ISO/IEC 23090-5) where semantics of the patch data is as follows:
   pdu_2d_pos_x stores the u value of texture map to the vertex
   pdu_2d_pos_y stores the v value of texture map to the vertex
   pdu_2d_size_x_minus1 equal to 0, ue(v) equal to 1 bit
   pdu_2d_size_y_minus1 equal to 0, ue(v) equal to 1 bit
   pdu_3d_offset_u stores x value of a vertex
   pdu_3d_offset_v stores y value of a vertex
   pdu_3d_offset_d stores z value of a vertex
   pdu_projection_id_set to 0 bits as descriptor is u(v)
   pdu_orientation_index-set to 0 bits as descriptor u(v)
Patches in an inter frame (e.g. a frame that has a reference to other frame) are stored as inter patch data unit. Some examples of inter patch data unit include, any type of V3C patch data units (e.g. patch_data_unit, skip_patch_data_unit, merge_patch_data_unit, or inter_patch_data_unit) with semantics aligned to semantics described for patch_data_unit in previous paragraph.
CLERS strings, e.g. connectivity information, are stored as:
   a new patch type that would store a string of bits, the string representing the history, e.g. example the following bit mapping to history string could be used C=0, L=110, E=111, R=101, S=100 pattern, or
   a new NAL unit type that would always precede NAL unit containing the corresponding atlas_tile_layer_rbsp syntax element.

TABLE 2
NAL unit type codes and NAL unit type classes

| | Name of | Content of NAL unit and | NAL unit |
|---|---|---|---|
| nal_unit_type | nal_unit_type | RBSP syntax structure | type class |
| 0 | NAL_TRAIL_N | Coded tile of a non-TSA, non | ACL |
| 1 | NAL_TRAIL_R | STSA trailing atlas frame | |
| | | atlas_tile_layer_rbsp( ) | |
| . . . | . . . | . . . | . . . |
| 56 | NAL_EB | edgebraker_rbsp | ACL |
| 57 . . . 63 | NAL_UNSPEC_57 | Unspecified non-ACL NAL | non-ACL |
| | NAL_UNSPEC_63 | unit types | |

| | Descriptor |
|---|---|
| edgebraker_rbsp( ){ | |
| eb_encoding_type | ue(v) |
| eb_clers_data_length | ue(v) |
| for(i = 0; i < eb_clers_data_length; i++) | |
| eb_clers_data[ i ] | u(1) |
| rbsp_trailing_bits( ) | u(1) |
| } | |

eb_encoding_type indicates a method to encode history CLERS string. For example, eb_encoding_type equal to 0 indicates the following bit mapping to history string is used C=0, L=110, E=111, R=101, S=100 pattern.

eb_clers_data_length indicates the length of data containing CLERS string in bits.

eb_clers_data may have any value. eb_clears_data includes i-th bit of the bitstream of length eb_clers_data_length describing CLERS string, where CLERS string binary representation/format is indicated by eb_encoding_type.

In an example, a new patch type may have syntax structure same or substantially same as an edgebraker_rbsp syntax structure.

In another embodiment, a vertex may have more than one uv value assigned per vertex. A uv mapping can be stored as part of a new patch type, or a new NAL unit type e.g. in an NAL_EB, as shown in Table 3 below:

TABLE 3
Syntax for storing uv mapping in edgebraker_rbsp

| | Descriptor |
|---|---|
| edgebraker_rbsp( ){ | |
| eb_uv_count | ue(v) |
| for(i = 0; i < eb_clers_data_length; i++) { | |
| eb_u [i] | ue(v) |
| eb_v [i] | ue(v) |
| } | |
| eb_encoding_type | ue(v) |
| eb_clers_data_length | ue(v) |
| for(i = 0; i < eb_clers_data_length; i++) | |
| eb_clers_data [ i ] | |
| rbsp_trailing_bits( ) | u(1) |
| } | |

eb_uv_count indicates the number of assigned uv values
eb_u [i] indicates the u position of uv coordinate with index i for a texture in associated attribute video frame
eb_v [i] i indicates the v position of uv coordinate with index i for a texture in associated attribute video frame

In yet another embodiment, a vertex may have more than one uv values assigned per vertex. The uv mapping may be stored as part of patch data_unit:
pdu_2d_pos_x, which indicates the number of uv values assigned to a patch (e.g. vertex)
pdu_2d_pos_y, which may be equal to 0 bit or equal to 1 bit
pdu_2d_size_x_minus1, which equals to 0 and ue(v) equals to 1 bit
pdu_2d_size_y_minus1, which equals to 0, and ue(v) equals to 1 bit

In an example, as shown in the Table 4 below, a uv extension is included in a patch data unit.

TABLE 4
Syntax for including uv indices in an extension in the patch data unit

| | Descriptor |
|---|---|
| patch_data_unit( tileID, patchIdx ) { | |
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_3d_offset_u[ tileID ][ patchIdx ] | u(v) |
| pdu_3d_offset_v[ tileID ][ patchIdx ] | u(v) |
| pdu_3d_offset_d[ tileID ][ patchIdx ] | u(v) |
| if( asps_normal_axis_max_delta_value_enabled_flag ) | |
| pdu_3d_range_d[ tileID ][ patchIdx ] | u(v) |
| pdu_projection_id[ tileID ][ patchIdx ] | u(v) |
| pdu_orientation_index[ tileID ][ patchIdx ] | u(v) |
| if( afps_lod_mode_enabled_flag ) { | |
| pdu_lod_enabled_flag[ tileID ][ patchIdx ] | u(1) |
| if( pdu_lod_enabled_flag[ tileID ][ patchIdx ] ) { | |
| pdu_lod_scale_x_minus1[ tileID ][ patchIdx ] | ue(v) |
| pdu_lod_scale_y_idc[ tileID ][ patchIdx ] | ue(v) |
| } | |
| } | |
| if( asps_plr_enabled_flag ) | |
| plr_data( tileID, patchIdx ) | |
| if( asps_miv_extension_present_flag ) | |
| pdu_miv_extension( tileID, patchIdx ) /* Specified in ISO/IEC 23090-12 */ | |
| if( asps_mesh_extension_present_flag && pdu_2d_pos_x ) { | |
| for( i = 0; i < pdu_2d_pos_x; i++) { | |
| pdu_mesh_uv_idx | ue(v) |
| } | |
| } | |
| } | |

pdu_mesh_uv_idx indicates index of eb_u and eb_v values listed in edgebraker_rbsp syntax element

In still another embodiment, as shown in Table 5 below, extension to patch_data_unit may be provided as a count of mapped uv values to a patch instead of reusing pdu_2d_pos_x.

TABLE 5
Syntax for storing count of uv indcies
in an extension to patch data unit

| | |
|---|---|
| if( asps_mesh_extension_present_flag && pdu_2d_pos_x ) { | |
| pdu_mesh_uv_count | ue(v) |
| for( i = 0; i < pdu_mesh_uv_count; i++) { | |
| pdu_mesh_uv_idx | ue(v) |
| } | |
| } | |

pdu_mesh_uv_count indicates the number of uv values assigned to the patch (e.g. vertex)

In still another embodiment, edgebreaker_rbsp may be provided on tile basis, e.g. eb_u and eb_v values may be in a tile reference system and not full atlas frame and eb_clers data may correspond only to patches in a given tile.

To map the information to a tile, an additional information, as shown in Table 6 may be provided:

TABLE 6
Syntax for storing uv to a tile mapping in edgebraker_rbsp

| | Descriptor |
|---|---|
| edgebraker_rbsp( ){ | |
| eb_tile_count | ue(v_{—} |
| for(j = 0; j < eb_tile_count; j++) { | |
| eb_uv_count[ j ] | ue(v) |
| for(i = 0; i < eb_clers_data_length[ j ]; i++) { | |
| eb_u [ j ][ i ] | ue(v) |
| eb_v [ j ][ i ] | ue(v) |
| } | |
| eb_encoding_type[ j ] | ue(v) |
| eb_clers_data_length[ j ] | ue(v) |
| for(i = 0; i < eb_clers_data_length[ j ]; i++) | |
| eb_clers_data [ j ][ i ] | |
| } | |
| rbsp_trailing_bits( ) | u(1) |
| } | |

In still another embodiment:
when a mesh has an edge, the vertices that describe the edge need to be indicated and stored one after another.
when vertices are encoded using parallelogram prediction this should be indicated.

This information may be indicated by re-utilizing an existing syntax element e.g.:
pdu_orientation_index where value
0 means vertex is from an edge
1 means vertex is not from an edge and is stored as is
2 means vertex is not from an edge and is predicted by using a parallelogram prediction

In still another embodiment, number of edge vertices, number of normal vertices (e.g. vertices that are not from an edge), and/or number of parallelogram vertices may be provided as part of:
a new patch type, or
a new NAL unit type e.g. in NAL_EB that contains edgebraker_rbsp sytax structure as shown in following Table 7:

TABLE 7
Syntax for storing information on edge
and normal vertices in edgebraker_rbsp

| | Descriptor |
|---|---|
| edgebraker_rbsp( ){ | |
| eb_edge_vertices_count | ue(v) |
| eb_norm_vertices_count | ue(v) |
| eb_paralelogram_vertices_count | ue(v) |
| eb_uv_count | ue(v) |
| for(i = 0; i < eb_clers_data_length; i++) { | |
| eb_u | ue(v) |
| eb_v | ue(v) |
| } | |
| eb_encoding_type | ue(v) |
| eb_clers_data_length | ue(v) |
| for(i = 0; i < eb_clers_data_length; i++) | |
| eb_clers_data | |
| rbsp_trailing_bits( ) | u(1) |
| } | |

eb_edge_vertices_count indicates number of vertices that are edge vertices.

eb_norm_vertices_count indicates number of vertices that are stored as is without parallelogram prediction.

eb_paralelogram_vertices_count indicates number of stored using parallelogram prediction.

Vertices stored in a tile as patch data unit are stored in consecutive manner, e.g. first eb_edge_vertices_count number of vertices that are edge vertices, next eb_norm_vertices_count number of vertices that are normal vertices, and finally eb_paralelogram_vertices_count number of vertices that are stored using parallelogram prediction.

In still another embodiment, as shown in Table 8 below, NAL_EB does not have to precede NAL unit containing the corresponding atlas_tile_layer_rbsp syntax element but contains explicit information to which tile it applies.

TABLE 8
Syntax for storing tile information in edgebraker_rbsp

| | Descriptor |
|---|---|
| edgebraker_rbsp( ){ | |
| ed_tile_id | ue(v) |
| eb_edge_vertices_count | ue(v) |
| eb_norm_vertices_count | ue(v) |
| eb_paralelogram_vertices_count | ue(v) |
| eb_uv_count | ue(v) |
| for(i = 0; i < eb_clers_data_length; i++) { | |
| eb_u | ue(v) |
| eb_v | ue(v) |
| } | |
| eb_encoding_type | ue(v) |
| eb_clers_data_length | ue(v) |
| for(i = 0; i < eb_clers_data_length; i++) | |
| eb_clers_data | |
| rbsp_trailing_bits( ) | u(1) |
| } | |

ed_tile_id specifies the tile ID to which the syntax elements in a given edgebraker_rbsp ( ) apply.

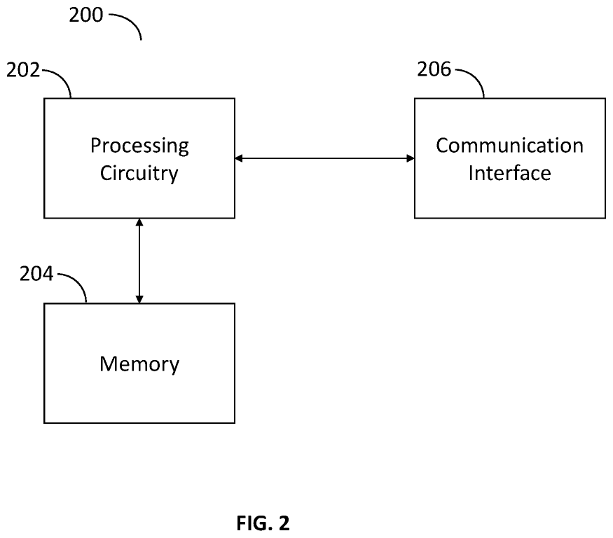

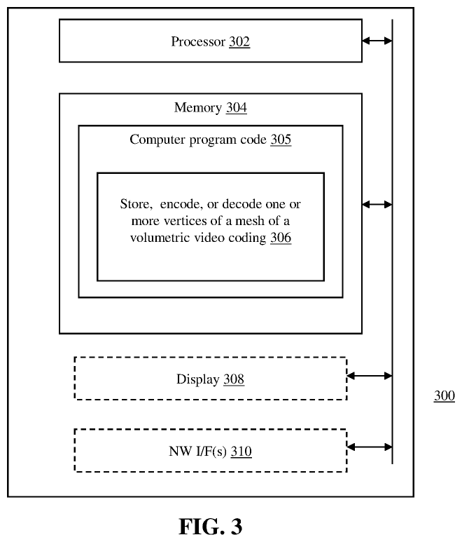

The method and apparatus of an example embodiment may be utilized in a wide variety of systems, including systems that rely upon, the encoding and/or decoding of meshes in a volumetric video coding bitstream. In some embodiments, the method and apparatus are configured to implement storage of edgebreaker data in a V3C bitstream. In other embodiments, the method and apparatus are configured to implement storage of a vertex of a mesh. In this regard, FIGS. 2 and 3 depict examples of such apparatuses.

FIG. 2 is a block diagram of an apparatus 200 that may be configured in accordance with an example embodiment. As shown in FIG. 2, the apparatus of an example embodiment includes, is associated with, or is in communication with a processing circuitry 202, one or more memory devices 204, a communication interface 206 and optionally a user interface.

The processing circuitry 202 may be in communication with the memory device 204 via a bus for passing information among components of the apparatus 200. The memory device 204 may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device 204 may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 200 may, in some embodiments, be embodied in various computing devices, for example, a personal digital assistant, a mobile telephone, an integrated messaging device, a desktop computer, a notebook computer, a set-top box, a gaming console, and the like. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single ‘system on a chip.’ As such, in some cases, a chip or chipset may constitute means for performing one or more operations for providing the functionalities described herein.

The processing circuitry 202 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 202 may be configured to execute instructions stored in the memory device 204 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processing circuitry to perform the algorithms and/or operations described herein when the instructions are executed. However, in some cases, the processing circuitry may be a processor of a specific device (e.g., an image or video processing system) configured to employ an embodiment of the present invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 206 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the apparatus 200 may optionally include a user interface that may, in turn, be in communication with the processing circuitry 202 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device, and/or the like).

In an embodiment, the apparatus 200 is configured to store of data of an algorithm for compression of a volumetric video coding, for example, storage of edgebreaker data in a V3C bitstream. In another embodiment, the apparatus 200 is configured to store a vertex of a mesh by using an extension to a volumetric video coding structure. In still another embodiment, the apparatus 200 is configured to encode/decode the vertex of the mesh of the volumetric video coding or the bitstream comprising the vertex of the mesh.

FIG. 3 is an example apparatus 300, which may be implemented in hardware, configured to encode, or decode a vertex of a mesh of a volumetric video coding, based on the examples described herein. The apparatus 300 comprises at least one processor 302, at least one non-transitory memory 304 including computer program code 305, wherein the at least one memory 304 and the computer program code 305 cause the apparatus 300 to store, encode/decode a vertex of a mesh of a volumetric video coding 306, or a bitstream comprising the vertex of the mesh, based on the examples described herein. In an example, the volumetric video coding includes V3C.

The apparatus 300 optionally includes a display 308 that may be used to display content during rendering. The apparatus 300 optionally includes one or more network (NW) interfaces (I/F(s)) 310. The NW I/F(s) 310 may be wired and/or wireless and communicate over the Internet/other network(s) via any communication technique. The NW I/F(s) 310 may comprise one or more transmitters and one or more receivers. The N/W I/F(s) 310 may comprise standard well-known components such as an amplifier, filter, frequency-converter, (de) modulator, and encoder/decoder circuitry(ies) and one or more antennas.

The apparatus 300 may be a remote, virtual or cloud apparatus. The apparatus 300 may be either a coder or a decoder, or both a coder and a decoder. The at least one memory 304 may be implemented using any suitable data storage technology, such as semiconductor based memory devices, flash memory, magnetic memory devices and systems, optical memory devices and systems, fixed memory and removable memory. The at least one memory 304 may comprise a database for storing data. The apparatus 300 need not comprise each of the features mentioned, or may comprise other features as well. The apparatus 300 may correspond to or be another embodiment of the apparatus 200 shown in FIG. 2.

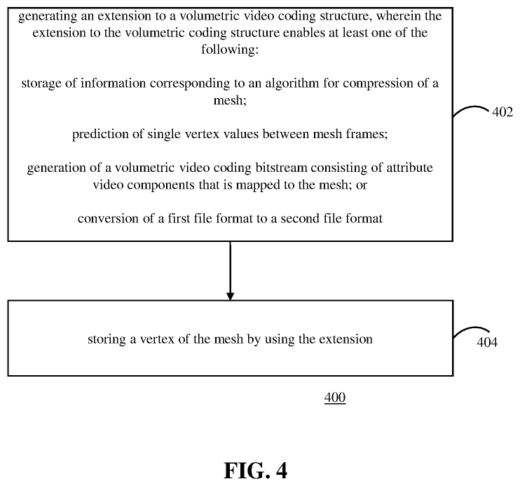

FIG. 4 illustrates an example method 400 for storing a vertex of a mesh of a volumetric video coding in a bitstream, in accordance with an embodiment. In an example, the volumetric video coding includes V3C and the bitstream includes a V3C bitstream. As shown in block 306 of FIG. 3, the apparatus 300 includes means, such as the processing circuitry 302 and at least one memory 304, storing the vertex of the mesh of the volumetric video coding. At 402, the method 400 includes generating an extension to a volumetric video coding structure. The extension to the volumetric coding structure enables at least one of the following:
storage of information corresponding to an algorithm for compression of a mesh;
prediction of single vertex values between mesh frames;
generation of a volumetric video coding bitstream consisting of attribute video components that is mapped to the mesh; or
conversion of a first file format to a second file format.

At 404, the method 400 includes storing the vertex of the mesh by using the extension.

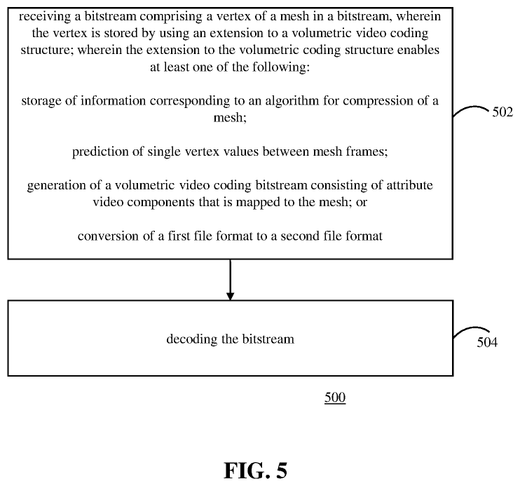

FIG. 5 illustrates an example method 500 for decoding a bitstream comprising a vertex of a mesh of a volumetric video, in accordance with an embodiment. In an example, the volumetric video coding includes V3C and the bitstream includes a V3C bitstream. As shown in block 306 of FIG. 3, the apparatus 300 includes means, such as the processing circuitry 302 and at least one memory 304, for decoding a vertex of a mesh of a volumetric video coding or decoding the bitstream comprising the vertex of the mesh. At 502, the method 500 includes receiving a bitstream comprising the vertex of the mesh, wherein the vertex is stored by using an extension to a volumetric video coding structure. The extension to the volumetric coding structure enables at least one of the following:
storage of information corresponding to an algorithm for compression of a mesh;
prediction of single vertex values between mesh frames;
generation of a volumetric video coding bitstream consisting of attribute video components that is mapped to the mesh; or
conversion of a first file format to a second file format.

At 504, the method 500 includes decoding the bitstream.

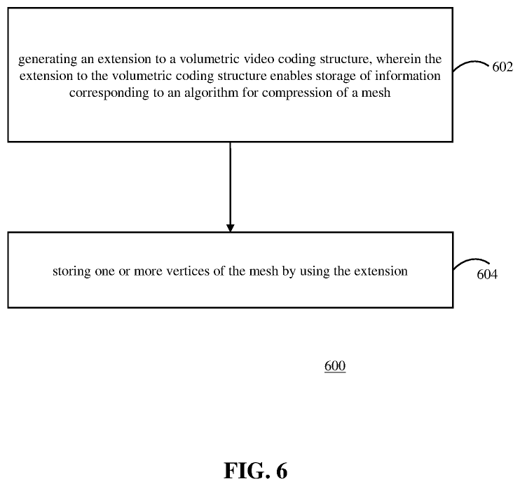

FIG. 6 illustrates an example method 600 for storing one or more vertices of a mesh of a volumetric video coding in a bitstream, in accordance with an embodiment. In an example, the volumetric video coding includes V3C and the bitstream includes a V3C bitstream. As shown in block 306 of FIG. 3, the apparatus 300 includes means, such as the processing circuitry 302 and at least one memory 304, storing one or more vertices of the mesh of the volumetric video coding. At 602, the method 600 includes generating an extension to a volumetric video coding structure. The extension to the volumetric coding structure enables storage of information corresponding to an algorithm for compression of a mesh.

At 604, the method 600 includes storing the one or more vertices of the mesh by using the extension.

In an embodiment, the extension further enables at least one of the following:
prediction of single vertex values between mesh frames;
generation of a volumetric video coding bitstream consisting of attribute video components that is mapped to the mesh; or
conversion of a first file format to a second file format.

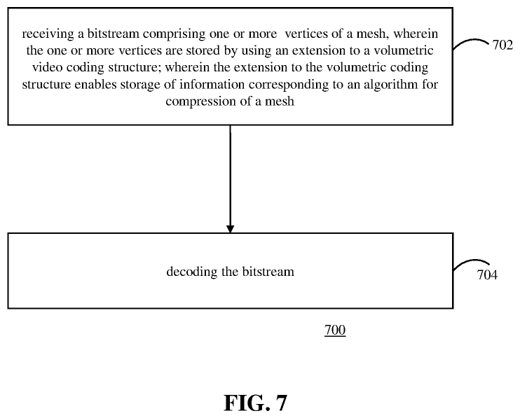

FIG. 7 illustrates an example method 700 for decoding a bitstream comprising one or more vertices of a mesh of a volumetric video, in accordance with an embodiment. In an example, the volumetric video coding includes V3C and the bitstream includes a V3C bitstream. As shown in block 306 of FIG. 3, the apparatus 300 includes means, such as the processing circuitry 302 and at least one memory 304, for decoding one or more vertices of a mesh of a volumetric video coding or decoding the bitstream comprising the one or more vertices of the mesh. At 702, the method 700 includes receiving a bitstream comprising the one or more vertices of the mesh, wherein the one or more vertices are stored by using an extension to a volumetric video coding structure. The extension to the volumetric coding structure enables storage of information corresponding to an algorithm for compression of a mesh.

At 704, the method 700 includes decoding the bitstream.

In an embodiment, the extension further enables at least one of the following:
prediction of single vertex values between mesh frames;
generation of a volumetric video coding bitstream consisting of attribute video components that is mapped to the mesh; or
conversion of a first file format to a second file format.

As described above, FIGS. 4 to 7 include a flowcharts of an apparatus (e.g. 200 or 300), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 204 or 304) of an apparatus employing an embodiment of the present invention and executed by processing circuitry (e.g. 202 or 302) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 4 to 7. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some example embodiments have been described with reference edgebreaker algorithm. It needs to be understood, however, that embodiments can be similarly realized with any similar algorithm used for compression of 3D meshes.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

1-168. (canceled)

169. A method comprising:
generating a volumetric video coding structure or an extension to the volumetric video coding structure, wherein the volumetric video coding structure or the extension to the volumetric video coding structure enables at least one of the following:
storage of information corresponding to an algorithm for compression of a mesh;
prediction of single vertex values between mesh frames;
generation of a volumetric video coding bitstream comprising attribute video components that is mapped to the mesh; or
conversion of a first file format to a second file format; and
storing a vertex of the mesh by using the volumetric video coding structure or the extension to the volumetric video coding structure.

170. The method of claim 169, wherein the volumetric video coding comprises a visual volumetric video-based coding (V3C), the volumetric video coding structure comprises V3C structure, and/or the volumetric video coding bitstream comprises a V3C bitstream.

171. A method comprising:
receiving a bitstream comprising a vertex of a mesh, wherein the vertex is stored by using a volumetric video coding structure or an extension to the volumetric video coding structure; wherein the volumetric video coding structure or the extension to the volumetric video coding structure enables at least one of the following:
storage of information corresponding to an algorithm for compression of the mesh;
prediction of single vertex values between mesh frames;
generation of a volumetric video coding bitstream comprising attribute video components that is mapped to the mesh; or
conversion of a first file format to a second file format; and
decoding the bitstream.

172. The method of claim 171, wherein the volumetric video coding comprises a visual volumetric video-based coding (V3C), the volumetric video coding structure comprises V3C structure, and/or the volumetric video coding bitstream comprises a V3C bitstream.

173. The method of claim 171, wherein the first file format comprises a three dimensional (3D) media format and the second file format comprises a visual volumetric video-based coding (V3C) format.

174. The method of claim 171, wherein the algorithm comprises an edgebreaker algorithm and the information corresponding to the algorithm comprises edgebreaker information.

175. The method of claim 171, wherein the information corresponding to the algorithm for compression of the mesh comprises at least one of a vertex information, mapping to a coordinate texture (uv) texture, or connectivity information.

176. An apparatus comprising at least one processor; and at least one non-transitory memory comprising computer program code, wherein the at least one non-transitory memory and the computer program code are configured to, with the at least one processor, cause the apparatus at least to perform:
generating a volumetric video coding structure or an extension to the volumetric video coding structure, wherein the volumetric video coding structure or the extension to the volumetric video coding structure enables at least one of the following:
storage of information corresponding to an algorithm for compression of a mesh;
prediction of single vertex values between mesh frames;
generation of a volumetric video coding bitstream comprising attribute video components that is mapped to the mesh; or
conversion of a first file format to a second file format; and
storing a vertex of the mesh by using the volumetric video coding structure or the extension to the volumetric video coding structure.

177. The apparatus of claim 176, wherein the volumetric video coding comprises a visual volumetric video-based coding (V3C), the volumetric video coding structure comprises V3C structure, and/or the volumetric video coding bitstream comprises a V3C bitstream.

178. The apparatus of claim 176, wherein the first file format comprises a three dimensional (3D) media format and the second file format comprises a visual volumetric video-based coding (V3C) format.

179. The apparatus of claim 176, wherein the algorithm comprises an edgebreaker algorithm and the information corresponding to the algorithm comprises edgebreaker information.

180. The apparatus of claim 176, wherein the information corresponding to the algorithm for compression of the mesh comprises at least one of a vertex information, mapping to a coordinate texture (uv) texture, or connectivity information.

181. The apparatus of claim 176, wherein the apparatus is further caused to perform: indicating that vertices are encoded using a parallelogram prediction, when the vertices are encoded using the parallelogram prediction.

182. An apparatus comprising at least one processor; and at least one memory comprising computer program code; wherein the at least one memory and the computer program code are configured to, with the at least one processor, cause the apparatus at least to perform:
receive a bitstream comprising a vertex of a mesh, wherein the vertex is stored by using a volumetric video coding structure or an extension to the volumetric video coding structure; wherein the volumetric video coding structure or the extension to the volumetric video coding structure enables at least one of the following:
storage of information corresponding to an algorithm for compression of the mesh;
prediction of single vertex values between mesh frames;
generation of a volumetric video coding bitstream comprising attribute video components that is mapped to the mesh; or
conversion of a first file format to a second file format; and
decoding the bitstream.

183. The apparatus of claim 182, wherein the volumetric video coding comprises a visual volumetric video-based coding (V3C), the volumetric video coding structure comprises V3C structure, and/or the volumetric video coding bitstream comprises a V3C bitstream.

184. The apparatus of claim 182, wherein the first file format comprises a draco (drc) file format and the second file format comprises a visual volumetric video-based coding (V3C) file format.

185. The apparatus of claim 182, wherein the algorithm comprises an edgebreaker algorithm and the information corresponding to the algorithm comprises edgebreaker information.

186. The apparatus of claim 182, wherein the information corresponding to the algorithm for compression of the mesh comprises at least one of a vertex information, mapping to a coordinate texture (uv) texture, or connectivity information.

187. The apparatus of claim 182, wherein the apparatus is further caused to perform:
accessing at least one of: order of vertices in the mesh or a connectivity information;
retrieving the vertex, an intra frame, and an inter frame in a volumetric video coding patch data; or
retrieving the connectivity information as one of: a new patch type capable of storing string of bits or a new network abstraction later (NAL) unit type.

188. The apparatus of claim 182, wherein the apparatus is further caused to perform: accessing information indicating that vertices are encoded using a parallelogram prediction, when the vertices are encoded using the parallelogram prediction.
